(19) United States
(12) Patent Application Publication
(10) Pub. No.: US 2013/0324136 A1
(43) Pub. Date: Dec. 5, 2013

(54) COMMUNICATION SYSTEM, BASE STATION APPARATUSES, AND TERMINAL DEVICES

(71) Applicants: Kozue Hirata, Osaka-shi (JP); Shinpei Toh, Osaka-shi (JP)

(72) Inventors: Kozue Hirata, Osaka-shi (JP); Shinpei Toh, Osaka-shi (JP)

(73) Assignee: SHARP KABUSHIKI KAISHA, Osaka-shi, Osaka (JP)

(21) Appl. No.: 13/984,900

(22) PCT Filed: Jan. 31, 2012
(86) PCT No.: PCT/JP2012/052066

§ 371 Date: Aug. 12, 2013

(30) Foreign Application Priority Data
Feb. 17, 2011 (JP) 2011-032556

(51) Int. Cl. H04W 16/14

(52) U.S. Cl. CPC H04W 16/14
USPC 455/447

(57) ABSTRACT

In a communication system, a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell. The communication system determines the number of streams to be transmitted by the second base station apparatus on the basis of information regarding the number of streams to be transmitted by the first base station apparatus. As a result, in a system in which interference between cells exists, interference may be reduced with a simple structure using transmit and receive filters.

### TECHNICAL FIELD

The present invention relates to a communication system, base station apparatuses, and terminal devices.

### BACKGROUND ART

In a system configured by a plurality of cells whose zone radii are different from each other, in the case where communication is performed using the same frequency band, interference between cells is a large issue. For example, there is a system in which there is a picocell or femtocell whose zone radius is small in a macrocell whose zone radius is large and that covers a wide region. For example, in such a system, in the case where a picocell base station (PeNB:Pico eNodeB) performs communication with a terminal (a picocell terminal) included in the picocell or a femtocell base station (HeNB:Home eNodeB) performs communication with a terminal (a femtocell terminal) included in the femtocell, a signal transmitted from a macrocell base station (MeNB:Macro eNodeB) to a macrocell terminal is a source that causes interference in the picocell terminal or the femtocell terminal. Here, the transmission power of a picocell base station or a femtocell base station whose zone radius is small is smaller than that of a macrocell base station. Thus, the effect of interference coming from a macrocell base station is large. Moreover, in the case where a picocell terminal is positioned near a macrocell base station, too, the effect of interference is large. Due to the effect of such interference, reception characteristics of a picocell terminal or those of a femtocell terminal are degraded. In contrast, in a macrocell terminal, a signal transmitted from a picocell base station or a femtocell base station causes interference. The transmission power in a picocell or in a femtocell is significantly smaller than that in a macrocell. In the case where a macrocell terminal is positioned near a small-zone cell or in the case where a plurality of small-zone cells exist in a macrocell, the macrocell terminal suffers significantly large interference.

In this way, a macrocell may be a source that causes interference in a picocell and a femtocell and vice versa. As a method for reducing interference in the case where a source that causes interference using the same frequency band exists, a method has been proposed in which the transmission power of a station that causes interference is controlled and interference caused by the station that causes interference and affecting a desired signal is reduced (NPL 1).

### CITATION LIST

### Non Patent Literature

NPL 1: “A method for suppressing down-link interference by using a network support between base stations in LTE-Advanced in which an indoor base station is arranged”, the Institute of Electronics, Information, and Communication Engineers; IEICE technical report; RCS2009-177; December 2009.

### SUMMARY OF INVENTION

### Technical Problem

As in NPL 1, in the case where a method for performing transmission power control on a station that causes interference is used to suppress interference given from a macrocell to a picocell or a femtocell, the characteristics of a macrocell are degraded since control is performed such that the transmission power of a macrocell base station becomes lower. As another method for preventing such degradation of the characteristics of a macrocell, there is a method in which different frequencies are used for transmission from a macrocell and for transmission from a picocell or a femtocell; however, in the case, there is an issue in that the frequency use efficiency decreases.

It is an object of the present invention to reduce, in small zone cells such as a picocell in a system in which interference between cells exists, interference coming from a macrocell with a simple structure using transmit and receive filters.

### Solution to Problem

The present invention provides a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell. In the communication system, the number of streams to be transmitted by the second base station apparatus is determined on the basis of information regarding the number of streams to be transmitted by the first base station apparatus.

A terminal device in the second cell may receive a desired signal while eliminating interference coming from the first cell.

In addition, the present invention provides a first base station apparatus in a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell. The first base station apparatus transmits information regarding the number of streams to be transmitted by the first base station apparatus, to the second base station apparatus.

In addition, the present invention provides a second base station apparatus in a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell. The second base station apparatus includes a number-of-streams determination unit that acquires information regarding the number of streams to be transmitted by the first base station apparatus and determines the number of streams to be transmitted by the second base station apparatus.

In addition, the present invention provides a second terminal device in a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell. The second terminal device includes a channel estimation unit that estimates an equivalent channel matrix for a signal on which precoding has been performed and that is transmitted by the first base station apparatus, a receive filter calculation unit that calculates a receive filter on the basis of the estimated equivalent channel matrix, and a receive filter multiplication unit that multiplies a reception signal and the calculated receive filter together.

The present specification includes the contents of the specification and/or the drawings of Japanese Patent Application No. 2011-032556, to which the present application claims priority.

### Advantageous Effects of Invention

By using the present invention, in a system in which interference between cells exists, interference may be reduced with a simple structure using transmit and receive filters. Moreover, by transmitting a signal without reducing the transmission power of a base station in a macrocell, a system may be configured which prevents degradation of characteristics of the macrocell and has a superior efficiency for frequency utilization.

### BRIEF DESCRIPTION OF DRAWINGS

FIG. 1 is a diagram illustrating an example of the structure of a communication system according to a first embodiment of the present invention.

FIG. 2 is a diagram illustrating a detailed example of a system structure according to the present embodiment.

FIG. 3 is a diagram illustrating an example of the structure of a base station apparatus M according to the present embodiment.

FIG. 4 is a diagram illustrating an example of the structure of a terminal device m according to the present embodiment.

FIG. 5 is a diagram illustrating an example of the structure of a base station apparatus F according to the present embodiment.

FIG. 6 illustrates the structure of a terminal device f according to the present embodiment.

FIG. 7 is a diagram illustrating an example of the structure of a communication system according to a second embodiment of the present invention.

FIG. 8 is a diagram illustrating a detailed example of a system structure according to the present embodiment.

FIG. 9 is a diagram illustrating an example of the structure of the base station apparatus F in a femtocell C3 according to the present embodiment.

FIG. 10 is a diagram illustrating an example of the structure of a terminal device f₁ (f₂) according to the present embodiment.

### DESCRIPTION OF EMBODIMENTS

In the following, embodiments of the present invention will be described in detail with reference to the drawings.

### First Embodiment

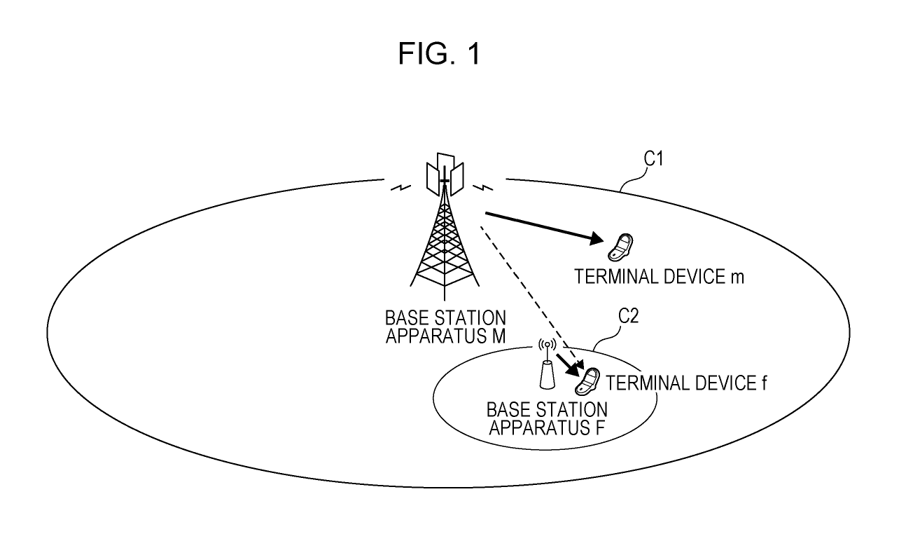

FIG. 1 illustrates an example of the structure of a communication system according to a first embodiment of the present invention. As illustrated in FIG. 1, there are a macrocell C1, which covers a wide area (and which is capable of performing communication over a wide area), and a femtocell C2, which covers a narrow area within the macrocell C1. The macrocell C1 is constituted by a base station apparatus M and one terminal device m. A desired signal is transmitted from the base station apparatus M to the terminal device m. The femtocell C2 is constituted by a base station apparatus F and one terminal device f. A desired signal is transmitted from the base station apparatus F to the terminal device f. Here, the terminal device f receives a desired signal transmitted to the terminal device m from the base station apparatus M as a signal that causes interference. Since the transmission power of the base station apparatus F is smaller than the transmission power of the base station apparatus M, the reception SINR (Signal to Interference plus Noise power Ratio) obtained in the terminal device f is degraded significantly. Note that a base station apparatus in the macrocell C1 is also called a MeNB (Macro eNodeB), and a base station apparatus in the femtocell C2 is also called a HeNB (Home eNodeB). In addition, here, an example is assumed in which the macrocell C1 and the femtocell C2 are used. However, cells or zones constituted by Remote Radio Equipment (RRE: Remote Radio Equipments), a picocell (PeNB: Pico eNodeB), HOTSPOT, a relay station, and the like may also be used as targets as long as a plurality of cells having different zone radii are a combination of cells such that a desired signal in one cell causes interference in another cell. Furthermore, the present embodiment may be applied to a situation in which a terminal device is positioned at a cell edge of two or more adjacent macrocells.

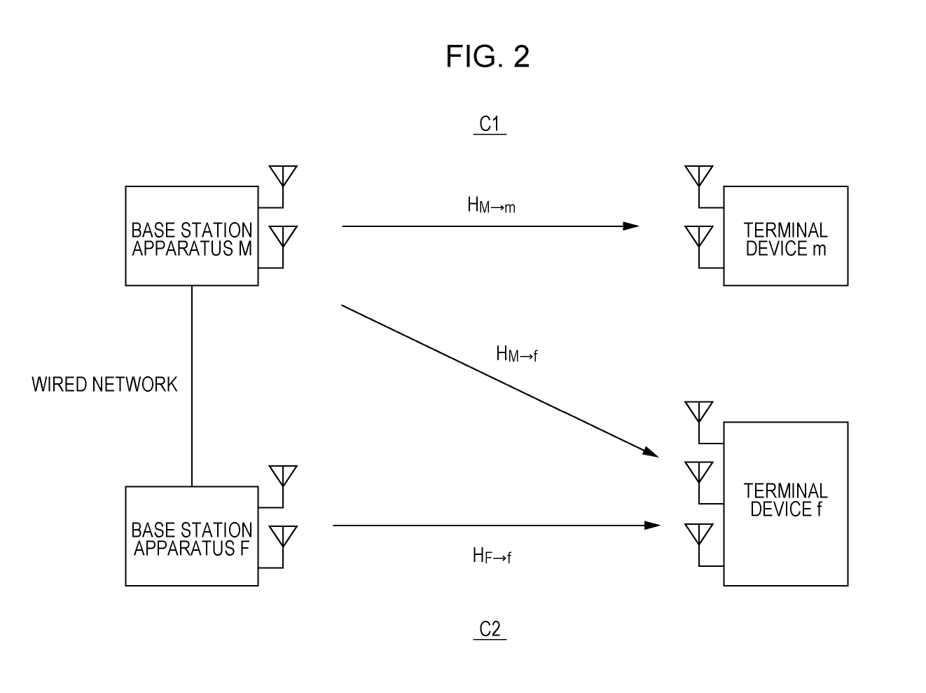

FIG. 2 illustrates a detailed example of the present system structure. In the macrocell C1, the base station apparatus M has two transmit antennas and the terminal device m has two receive antennas. Two stream signals are transmitted using SU-MIMO (Single User-MIMO) from the base station apparatus M to the terminal device m. Here, a channel matrix between the base station apparatus M and the terminal device m, from the base station apparatus M to the terminal device m, is denoted by H_{M→m}. Note that, here, it is assumed that transmission is performed using SU-MIMO in the macrocell C1; however, a structure may also be used in which there are two terminal devices and transmission is performed using MU-MIMO (Multi User-MIMO). In addition, here, the terminal device m is positioned at a point sufficiently apart from a femtocell, and interference from the femtocell C2 is not taken into account.

In the femtocell C2, the base station apparatus F has two transmit antennas and the terminal device f has three receive antennas. Here, a channel matrix between the base station apparatus F and the terminal device f, from the base station apparatus F to the terminal device f, is denoted by H_{F→f}. In addition, a channel matrix between the base station apparatus M and the terminal device f, from the base station apparatus M to the terminal device f, is denoted by H_{M→f}. A desired signal transmitted from the base station apparatus M to the terminal device m travels through a channel having the channel matrix H_{M→f} and is received by the terminal device f as a signal that causes interference.

Moreover, the base station apparatus M and the base station apparatus F are connected with each other via a wired network (or may be connected in a wireless manner in the case of relaying). Information may be shared between the base station apparatuses M and F. Note that, a general RRE or a picocell base station often transmits information to and receives information from the base station apparatus M via an optical fiber or a dedicated network. The femtocell base station F often transmits information to and receives information from the base station apparatus M via the Internet, the femtocell base station F being connected to the Internet using an ADSL (Asymmetric Digital Subscriber Line) or an optical fiber.

<About Macrocell>

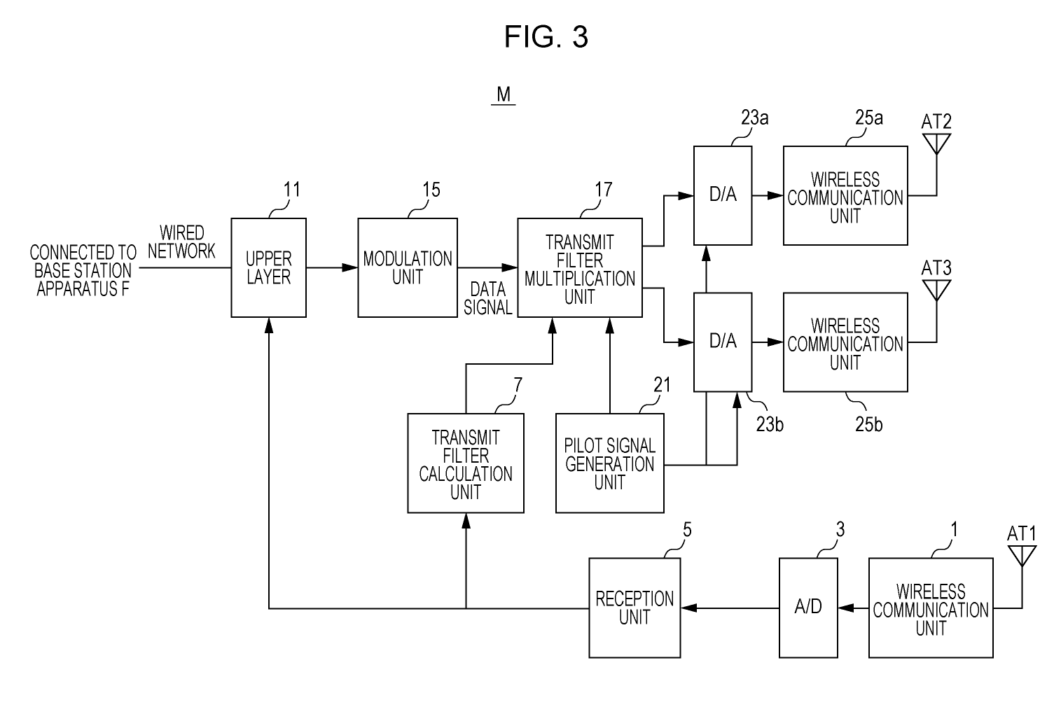

FIG. 3 illustrates the structure of the base station apparatus M according to the present embodiment. In the base station apparatus M illustrated in FIG. 3, a transmit filter W_{TX(m)} for performing transmission using SU-MIMO to the terminal m is calculated and precoding is performed. Here, precoding may be performed in which the number of streams is multiplexed on the basis of the channel matrix H_{M→m} between the base station apparatus M and the terminal device m and number-of-streams information Rₘ (also called RI: Rank Indicator) representing the number of streams to be transmitted from the base station apparatus M to the terminal device m. The terminal device m transmits, in advance, the channel matrix H_{M→m} estimated from a pilot signal and the number-of-streams information Rₘ to the base station apparatus M. As described above, in the present embodiment, in a macrocell, two stream signals are transmitted using SU-MIMO and Rₘ=2.

A receive antenna AT1 receives a signal transmitted from the terminal device m and outputs the signal to a wireless communication unit 1. The wireless communication unit 1 downconverts a reception signal input from the receive antenna AT1 and generates a baseband signal. The wireless communication unit 1 outputs the baseband signal to an A/D (Analog to Digital) unit 3. The A/D unit 3 converts an input analog signal into a digital signal and outputs the digital signal to a reception unit 5. The reception unit 5 extracts the channel matrix H_{M→m} and the number-of-streams information Rₘ from an input digital signal and outputs the channel matrix H_{M→m} to a transmit filter calculation unit 7 and the number-of-streams information Rₘ to an upper layer 11. From among these pieces of information, the number-of-streams information Rₘ is transmitted to the base station apparatus F via a wired network. Note that, here, Rₘ fed back from the terminal device m is simply transmitted to the base station apparatus F; however, a structure different from this may be used in which new Rₘ is calculated in the base station apparatus M on the basis of Rₘ fed back from the terminal device m by taking various situations into account and Rₘ calculated in the base station apparatus M is transmitted to the base station apparatus F. In addition, the number-of-streams information Rₘ here represents the number of streams on which spatial multiplexing is performed in a certain resource (also called a frame, a slot, a resource block, or the like).

The transmit filter calculation unit 7 calculates the transmit filter W_{TX(m)} from the channel matrix H_{M→m} input from the reception unit 5. Here, the transmit filter W_{TX(m)} is a filter for performing precoding in the base station apparatus M. As long as transmission of signals, the number of which is represented by the number-of-streams information Rₘ, is realized from the base station apparatus M to the terminal device m, any filter may be used. Here, a ZF (Zero Forcing) filter expressed as Equation (1) is used as an example of a transmit filter that spatially multiplexes two streams. In addition, precoding may also be performed such that eigenmode transmission is performed using a transmit-receive filter obtained by performing singular value decomposition (SVD: Singular Value Decomposition) on the channel matrix H_{M→m}. Furthermore, a transmit filter is selected from among a plurality of transmit filters, which are called a code book and are predetermined alternatives, signals are subjected to spatial multiplexing using the selected transmit filter and are then transmitted. The number of the signals is equal to the number of streams. Since transmission is performed using SU-MIMO, a structure may be used in which transmission is performed without performing precoding and a plurality of streams may be separated from each other on the terminal side by performing reception based on MMSE (Minimum Mean Square Error) criterion or the like.

[Math. 1]

W_{TX(m)}=H_{M→m}⁻¹ (1)

In the upper layer 11, a transmission information symbol dₘ for the number-of-streams information Rₘ input from the reception unit 5 is generated and is output to a modulation unit 15. The modulation unit 15 modulates the transmission information symbol dₘ into a transmission data signal sₘ using a modulation method such as QPSK (Quadrature Phase Shift Keying), 16QAM (Quadrature Amplitude Modulation), or the like. The modulation unit 15 outputs the transmission data signal sₘ to a transmit filter multiplication unit 17. The transmit filter multiplication unit 17 multiplies the transmission data signal sₘ and the transmit filter W_{TX(m)} together as expressed by Equation (2) and performs precoding to generate a transmission signal xₘ.

[Math. 2]

xₘ=W_{TX(m)}sₘ (2)

Note that, normally, the transmission power of the base station apparatus M is limited in accordance with the maximum transmission power per one transmit antenna and the like. Thus, there may be a case in which a signal obtained by multiplying xₘ expressed as Equation (2) and a certain coefficient together is treated as a transmission signal in order to make the power of the transmission signal xₘ obtained after precoding processing be lower than or equal to a limit value. However, in order to simplify the description here, a coefficient used to limit transmission power is not taken into account.

In addition, the base station apparatus M multiplexes the transmission signal xₘ and a pilot signal for channel estimation to demodulate a data signal, and transmits a resulting signal. A pilot signal for channel estimation is used to estimate an equivalent channel matrix H_{M→m}W_{TX(m)} in the terminal device m. Thus, the base station apparatus M transmits a signal obtained by multiplying a known pilot signal and the transmit filter W_{TX(m)} together and makes the terminal device m estimate the equivalent channel matrix H_{M→m}W_{TX(m)}. Here, in the present embodiment, a ZF filter is used as a transmit filter and two transmission data are received in a state in which the two transmission data are separated from each other. Thus, it is not always necessary to estimate the equivalent channel matrix H_{M→m}W_{TX(m)}; however, in the case where changes may occur in a channel between the time when the channel matrix H_{M→m} was estimated and the time when data transmission is performed or in the case where another transmit filter is used, it is necessary to estimate an equivalent channel matrix using a pilot signal. In this way, estimation of the equivalent channel matrix H_{M→m}W_{TX(m)} makes it possible to perform reception based on MMSE criterion or the like using this equivalent channel matrix.

A pilot signal generation unit 21 generates a known pilot signal and outputs the known signal to the transmit filter multiplication unit 17. The transmit filter multiplication unit 17 multiplies the input known pilot signal and the transmit filter W_{TX(m)} together and output a resulting signal and the transmission signal xₘ to D/A (Digital to Analog) units 23a and 23b. The D/A units 23a and 23b convert a multiplexed signal from a digital signal into an analog signal. Wireless communication units 25a and 25b upconvert the frequency of the input analog signal to a radio frequency and transmit a resulting signal to the terminal device m via transmit antennas AT2 and AT3.

In addition, the base station apparatus M in the present embodiment transmits a pilot signal for estimating the channel matrix H_{M→m}, the channel matrix H_{M→m} being estimated by the terminal device m. Note that, unlike the above-described pilot signal, this pilot signal and a transmit filter are not multiplied together. Thus, the known pilot signal generated by the pilot signal generation unit 21 is output to the D/A 23a and 23b and then to the wireless communication units 25a and 25b, and transmitted from the transmit antennas AT2 and AT3. Here, the pilot signal used to estimate the channel matrix H_{M→m} and a data signal or the like do not have to be multiplexed, and they may be transmitted at different times (in different frames). Moreover, transmission is performed using time resources or the like that are orthogonal to one another such that the pilot signals transmitted from the transmit antennas AT2 and AT3 do not interfere with each other on the reception side. Here, in a multicarrier transmission system, pilot signals may be transmitted from the transmit antennas AT2 and AT3 using different sub-carriers. Moreover, a structure may be used in which, orthogonal pilot signals are generated by multiplying each pilot signal and a corresponding orthogonal code together and transmitted.

The signal xₘ transmitted from the base station apparatus M to the terminal device m passes through a channel having the channel matrix H_{M→m}, and the terminal device m receives a signal expressed as Equation (3). Note that a noise component added at the terminal device m will be ignored in order to simplify the description.

$$\begin{matrix}[ Math . 3 ] & \\ \begin{matrix}{y}_{m} = {H}_{M \to m} {x}_{m} \\ = {H}_{M \to m} {W}_{TX ( m )} {s}_{m} \\ = {s}_{m}\end{matrix} & ( 3 )\end{matrix}$$

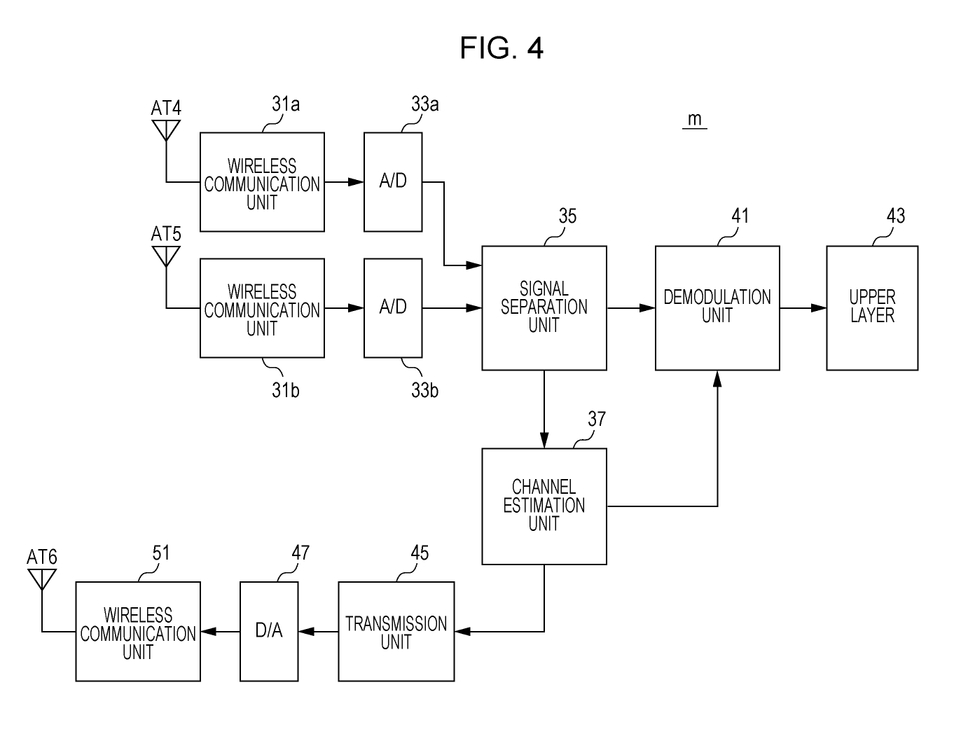

FIG. 4 illustrates the structure of the terminal device m according to the present embodiment. Receive antennas AT4 and AT5 receive signals transmitted from the base station apparatus M. Wireless communication units 31a and 31b downconvert reception signals input from the receive antennas AT4 and AT5 and generate baseband signals. A/D units 33a and 33b convert input analog signals into digital signals and output the digital signals to a signal separation unit 35. The signal separation unit 35 separates an input signal into a pilot signal for channel estimation and a reception data. The signal separation unit 35 outputs the pilot signal for channel estimation to a channel estimation unit 37 and outputs the reception data to a demodulation unit 41. The channel estimation unit 37 estimates the equivalent channel matrix H_{M→m}W_{TX(m)} on the basis of a pilot signal, which has been added to a data signal and transmitted, and inputs the equivalent channel matrix H_{M→m}W_{TX(m)} to the demodulation unit 41. As described above, in the present embodiment, precoding using a ZF filter is performed in the base station apparatus M. Thus, it is not always necessary to estimate the equivalent channel matrix H_{M→m}W_{TX(m)} and use it to perform demodulation; however, such estimation is necessary in the case where the demodulation unit 41 performs processing using the equivalent channel matrix such as reception based on MMSE criterion or the like. The demodulation unit 41 demodulates reception data input from the signal separation unit 35 and outputs resulting data to an upper layer 43.

Moreover, the channel estimation unit 37 estimates the channel matrix H_{M→m} on the basis of the known pilot signal generated by the pilot signal generation unit 21 illustrated in FIG. 3, and outputs the channel matrix H_{M→m} to a transmission unit 45. The transmission unit 45 converts the channel matrix H_{M→m} into a format in which the channel matrix H_{M→m} may be transmitted. A D/A unit 47 converts the channel matrix H_{M→m} from a digital signal into an analog signal. Thereafter, the converted channel matrix H_{M→m} is transmitted, via a wireless communication unit 51, to the base station apparatus M from a transmit antenna AT6. By performing such processing, channels between the transmit antennas of the base station apparatus M and the receive antennas of the terminal device m are estimated, each channel being obtained between a corresponding one of the transmit antennas of the base station apparatus M and a corresponding one of the receive antennas of the terminal device m. Results obtained from the estimation may be fed back to the base station apparatus M.

<About Femtocell>

In the femtocell C2, the terminal device f receives a desired signal from the base station apparatus F and interference from the macrocell C1. In the femtocell C2, the following processing is performed in order that a desired signal is received without being affected by interference coming from the macrocell C1.

The terminal device f calculates a receive filter for eliminating interference coming from the macrocell C1, and extracts a desired signal by multiplying a reception signal and this receive filter together. Moreover, the base station apparatus F determines the number of streams to be transmitted to the terminal device f on the basis of information transmitted from the terminal device f (information on the number of receive antennas of the terminal device f) and the number-of-streams information Rₘ about the base station apparatus M. Furthermore, the base station apparatus F determines a transmit filter by using information about a channel transmitted from the terminal device f and information about the receive filter, and performs precoding.

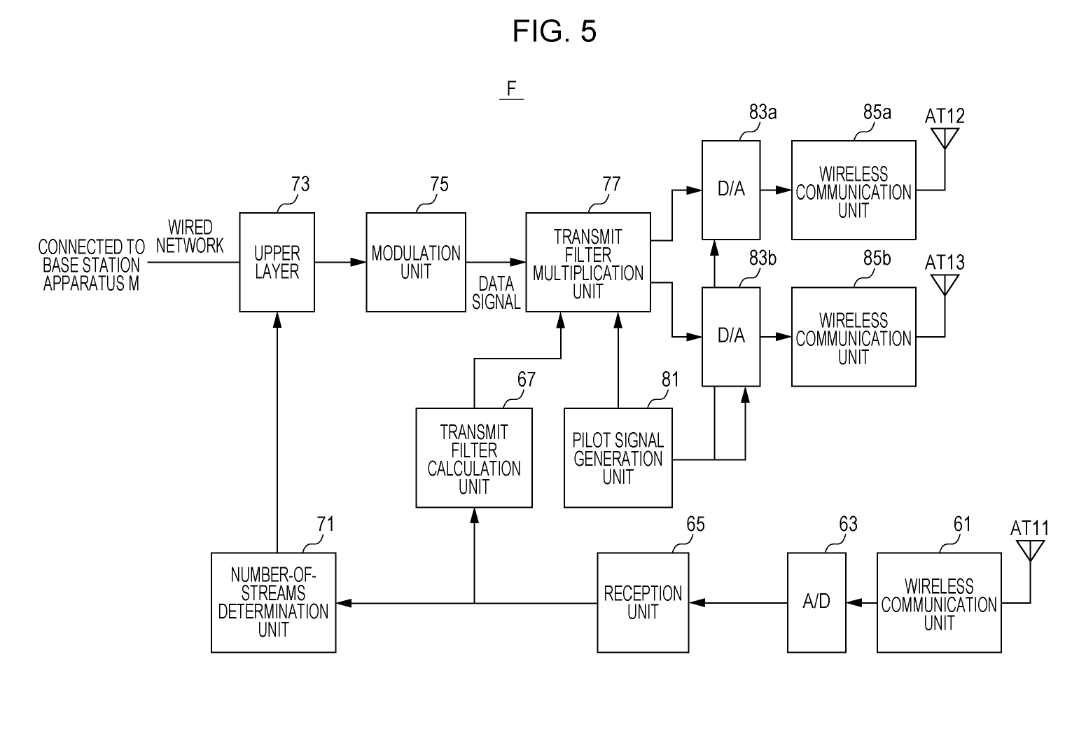

FIG. 5 illustrates an example of the structure of the base station apparatus F according to the present embodiment.

A receive antenna AT11 receives a signal transmitted from the terminal device f. A wireless communication unit 61 downconverts a reception signal input from the receive antenna AT11 and generates a baseband signal. An A/D unit 63 converts an input analog signal into a digital signal and outputs the digital signal to a reception unit 65. The reception unit 65 extracts, from an input digital signal, information transmitted from the terminal device f. Specifically, the reception unit 65 extracts a channel matrix H_{F→f}, number-of-receive-antennas information N_{f} on the terminal device f, and a receive filter W_{RX(f)} of the terminal device f. The reception unit 65 outputs the channel matrix H_{F→f} and the receive filter W_{RX(f)} to a transmit filter calculation unit 67 and the number-of-receive-antennas information N_{f} to a number-of-streams determination unit 71.

Note that a structure may be used in which an equivalent channel matrix H_{F→f}W_{RX(f)} obtained by multiplying the channel matrix H_{F→f} and the receive filter W_{RX(f)} together is fed back from the terminal device f and the equivalent channel matrix is extracted in the base station apparatus F. Moreover, the number-of-receive-antennas information N_{f} does not have to be regularly transmitted. The terminal device f may be configured such that the terminal device f transmits the number-of-receive-antennas information N_{f} only once in the case where an initial connection is established with the base station apparatus F.

In the base station apparatus F in the present embodiment, the number-of-streams determination unit 71 determines the number of streams R_{F} using Equation (4) on the basis of the information fed back in this way. The number-of-streams determination unit 71 outputs the number of streams R_{F} to an upper layer.

[Math. 4]

R_{F}≦N_{f}−Rₘ (4)

Here, Rₘ represents the number of streams to be transmitted to the terminal device m from the base station apparatus M. For example, this information may be shared between the base station apparatus M and the base station apparatus F via a wired network to which the base station apparatus M and the terminal device m are connected. In the present embodiment, the information has been transmitted in advance from the base station apparatus M to the base station apparatus F.

In the present embodiment, N_{f}=3 and Rₘ=2. Thus, the number-of-streams determination unit 71 determines R_{F}≦1. That is, in this case, the terminal device f having three receive antennas receives interference in two streams from a macrocell and a desired signal in maximum one stream within the femtocell. In addition, in the case where N_{f}=3 and Rₘ=1, R_{F}≦2 and maximum two streams are transmitted using SU-MIMO within the femtocell. In the case where N_{f}=3 and Rₘ=0 (no signal is transmitted within the macrocell), R_{F}≦3 and maximum three streams are transmitted using SU-MIMO within the femtocell. Furthermore, in the case where N_{f}=3 and Rₘ=3, R_{F}=0. In this case, transmission using the same frequency channel as that of the macrocell is not performed in the femtocell.

This is because it is necessary to meet a condition indicating that the number of receive antennas is greater than or equal to the sum of the number of signals that cause interference and the number of desired streams, in order to receive a desired signal for the femtocell while eliminating interference coming from the macrocell using a linear filter in a terminal within the femtocell. Thus, in the present embodiment, this is determined by Equation (4). Note that, in the present embodiment, the number of streams to be transmitted in the femtocell is adjusted on the basis of the number of signals that cause interference coming from the macrocell; however, as long as the relationship expressed as Equation (4) is satisfied, it is possible to adjust the number of streams (number-of-streams information Rₘ) within the macrocell in accordance with the number of streams (number-of-streams information R_{F}) that are desired to be transmitted within the femtocell. In this case, information on the number of streams that are desired to be transmitted in the base station apparatus F and on the number of receive antennas that the terminal device f has is transmitted from the base station apparatus F to the base station apparatus M via a wired network. The number of streams to be transmitted in the macrocell is determined by the base station apparatus M using the information and Equation (4). Moreover, a structure may be used in which the number of streams that may be transmitted in the macrocell is determined by the base station apparatus F and information on the number of streams is transmitted to the base station apparatus M.

Moreover, as described above, it is desirable that the number of receive antennas of a terminal in the femtocell meet a condition for being greater than or equal to the sum of the number of signals that cause interference and the number of desired streams. As long as this condition is met, the number of streams in the femtocell may be determined using an equation different from Equation (4).

As expressed by Equation (5), the transmit filter calculation unit 67 calculates a transmit filter W_{TX(f)} from the channel matrix H_{F→f} and the receive filter W_{RX(f)} transmitted from the terminal device f. Here, the transmit filter W_{TX(f)} is a transmit filter for performing precoding in the base station apparatus F.

[Math. 5]

W_{TX(f)}=(W_{RX(f)}H_{F→f})^{H} (5)

In an upper layer 73, a transmission information symbol d_{f} for the number-of-streams information R_{F} is generated and is output to a modulation unit 75. The modulation unit 75 obtains a transmission data signal s_{f} by modulating the transmission information symbol d_{f}, and outputs the transmission data signal s_{f} to a transmit filter multiplication unit 77. The transmit filter multiplication unit 77 multiplies the transmission data signal s_{f} and the transmit filter W_{TX(f)} together and performs precoding processing for generating a transmission signal x_{f} as expressed by Equation (6).

[Math. 6]

x_{f}=W_{TX(f)}s_{f} (6)

Even in Equation (6), similarly as in Equation (2), there may be a case where a signal obtained by multiplying x_{f} and a coefficient for limiting transmission power together is treated as a transmission signal. However, this is not taken into account here.

A pilot signal generation unit 81 generates a known pilot signal and outputs the known pilot signal to the transmit filter multiplication unit 77. The transmit filter multiplication unit 77 multiplies an input known pilot signal and the transmit filter W_{TX(f)} together and outputs a resulting signal together with the transmission signal x_{f} to D/A units 83a and 83b. The D/A units 83a and 83b convert a multiplexed signal from a digital signal into an analog signal. Wireless communication units 85a and 85b upconvert the frequency of an input analog signal to a radio frequency and transmit a resulting signal to the terminal device f via transmit antennas AT12 and AT13.

Moreover, the base station apparatus F in the present embodiment transmits a pilot signal for estimating the channel matrix H_{F→f}, the channel matrix H_{F→f} being estimated by the terminal device f. This pilot signal is similar to the pilot signal for estimating the channel matrix H_{M→m} in the base station apparatus M. A known pilot signal generated by the pilot signal generation unit 81 is output to the D/A 83a and 83b and then to the wireless communication units 85a and 85b, and transmitted from the transmit antennas AT12 and AT13.

Here, the pilot signal for estimating the channel matrix H_{F→f} and a data signal or the like do not have to be multiplexed, and they may be transmitted at different times (in different frames). Moreover, transmission is performed using time resources or the like that are orthogonal to one another such that the pilot signals transmitted from the transmit antennas AT12 and AT13 do not interfere with each other on the reception side. Here, in a multicarrier transmission system, pilot signals may be transmitted from the transmit antennas using different sub-carriers. Moreover, a structure may be used in which, orthogonal pilot signals are generated by multiplying each pilot signal and a corresponding orthogonal code together and transmitted.

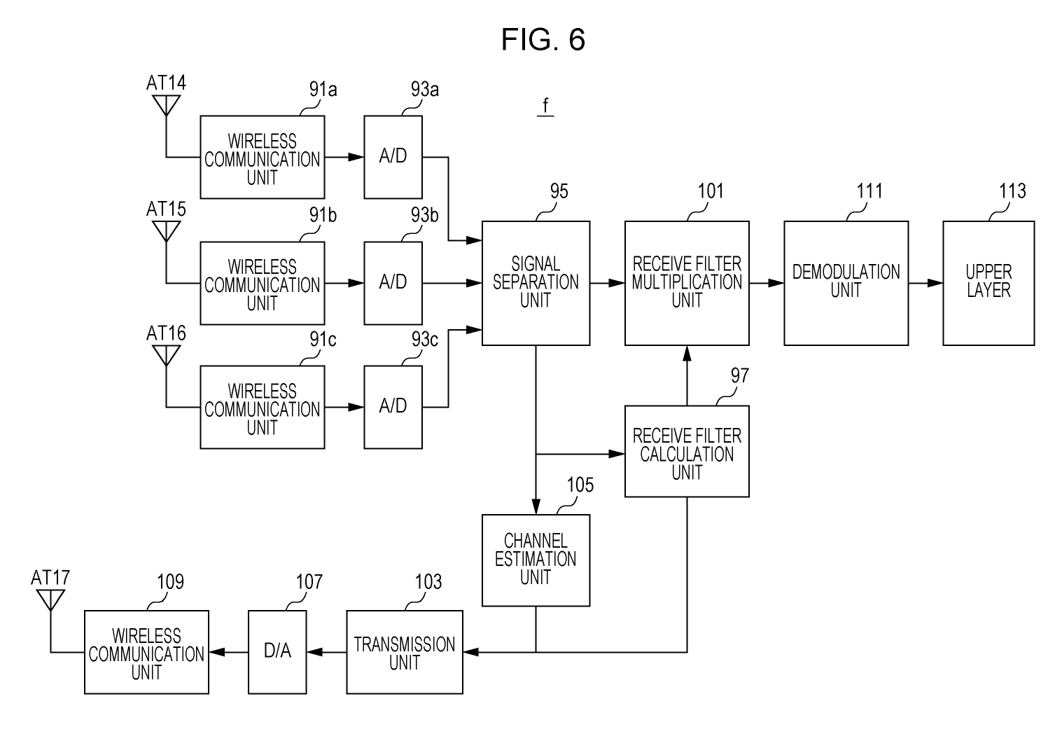

FIG. 6 illustrates the structure of the terminal device f according to the present embodiment.

The terminal device f receives a signal transmitted from the base station apparatus M in the macrocell, prior to transmission of a desired signal from the base station apparatus F in the femtocell described above. Wireless communication units 91a, 91b, and 91c downconvert reception signals input from receive antennas AT14, AT15, and AT16 and generate baseband signals. A/D units 93a, 93b, and 93c convert input analog signals into digital signals and output resulting signals to a signal separation unit 95. The signal separation unit 95 separates a pilot signal from an input signal, and outputs the pilot signal to a receive filter calculation unit 97.

The receive filter calculation unit 97 estimates an equivalent channel matrix H_{M→f}W_{TX(m)} between the base station apparatus M and the terminal device f from a pilot signal for receive filter calculation. As expressed by Equation (7), singular value decomposition (SVD: Singular Value Decomposition) is performed on the complex conjugate transpose of the equivalent channel matrix H_{M→f}W_{TX(m)}.

[Math. 7]

(H_{M→f}W_{TX(m)})^{H}=UDV^{H} (7)

Here, the receive filter W_{TX(f)} is the complex conjugate transpose vector of a right-singular vector, which corresponds to zero that is a diagonal element of a singular value matrix D, from among right-singular vectors V obtained by performing SVD on Equation (7). This indicates that a signal transmitted from a macrocell base station M of the macrocell and an obtained vector are multiplied together and a resulting signal is zero. That is, a vector that may eliminate a signal coming from the macrocell base station M of the macrocell is calculated as a receive filter. Note that, here, SVD is performed on the complex conjugate transpose of the equivalent channel matrix H_{M→f}W_{TX(m)}; however, a receive filter may be calculated by performing SVD on the equivalent channel matrix H_{M→f}W_{TX(m)}. In this case, the complex conjugate transpose vector of a left-singular vector, which corresponds to zero that is a diagonal element of a singular value matrix D, is used as a receive filter. The receive filter calculation unit 97 outputs the calculated receive filter W_{RX(f)} to a receive filter multiplication unit 101 and a transmission unit 103.

Moreover, the terminal device f performs channel estimation using a pilot signal for estimating the channel matrix H_{F→f}, the pilot signal being transmitted from the base station apparatus F. A channel estimation unit 105 estimates the channel matrix H_{F→f} on the basis of a known pilot signal generated by the pilot signal generation unit 21 in FIG. 3 and transmits the channel matrix H_{F→f} to the transmission unit 103.

The transmission unit 103 converts the channel matrix H_{F→f}, the receive filter W_{RX(f)}, and the number-of-receive-antennas information N_{f} into a format in which the channel matrix H_{F→f}, the receive filter W_{RX(f)}, and the number-of-receive-antennas information N_{f} may be transmitted. After a D/A unit 107 has performed conversion from a digital signal into an analog signal, a resulting signal is transmitted, via a wireless communication unit 109, from a transmit antenna unit AT17 to the base station apparatus F. By performing such processing, information necessary for the base station apparatus F is fed back from the terminal device f. Note that, as described above, the number-of-receive-antennas information N_{f} does not have to be regularly transmitted.

As described above, the number of streams to be transmitted is determined on the basis of the number-of-streams information Rₘ transmitted from the base station apparatus M in the macrocell and the number-of-receive-antennas information N_{f} fed back from the terminal device f. Precoding is performed on data signals, the number of which is equal to the number of streams. In the case where the terminal device f receives a data signal transmitted from the base station apparatus F, a reception signal is expressed as Equation (8). Note that a noise component added at the terminal device f will be ignored in order to simplify the description. As expressed by Equation (8), a reception signal y_{f} is expressed as the sum of a component of a desired signal x_{f} transmitted from the base station apparatus F and a component of a signal that causes interference transmitted from the base station apparatus M to the terminal device m. Here, the channel matrix H_{F→f} is a channel matrix between the base station apparatus F and the terminal device f, from the base station apparatus F to the terminal device f. The channel matrix H_{M→f} is a channel matrix between the base station apparatus M and the terminal device f, from the base station apparatus M to the terminal device f.

$$\begin{matrix}[ Math . 8 ] & \\ \begin{matrix}{y}_{f} = {H}_{F \to f} {x}_{f} + {H}_{M \to f} {x}_{m} \\ = {H}_{F \to f} {W}_{TX ( f )} {s}_{f} + {H}_{M \to f} {W}_{TX ( m )} {s}_{m}\end{matrix} & ( 8 )\end{matrix}$$

The receive antennas AT14, AT15, and AT16 receive a signal expressed as Equation (8). The wireless communication units 91a, 91b, and 91c downconvert reception signals input from the receive antennas AT14, AT15, and AT16 and generate baseband signals. The A/D units 93a, 93b, and 93c convert input analog signals into digital signals and output resulting signals to the signal separation unit 95. The signal separation unit 95 separates input signals into a pilot signal for estimating an equivalent channel matrix H_{F→f}W_{TX(f)} and reception data, and outputs the pilot signal for estimating the equivalent channel matrix H_{F→f}W_{TX(f)} to a channel estimation unit 105 and the reception data to the receive filter multiplication unit 101.

In the case where the receive filter multiplication unit 101 multiplies the reception data input from the signal separation unit 95 and the receive filter W_{RX(f)} input from the receive filter calculation unit 97 together, Equation (9) is obtained.

$$\begin{matrix}[ Math . 9 ] & \\ \begin{matrix}{W}_{RX ( f )} {y}_{f} = {W}_{RX ( f )} ( {H}_{F \to f} {W}_{TX ( f )} {s}_{f} + {H}_{M \to f} {W}_{TX ( m )} {s}_{m} ) \\ = {W}_{RX ( f )} {H}_{F \to f} {W}_{TX ( f )} {s}_{f} + {W}_{RX ( f )} {H}_{M \to f} {W}_{TX ( m )} {s}_{m} \\ = {W}_{RX ( f )} {{H}_{F \to f} ( {W}_{RX ( f )} {H}_{F \to f} )}^{H} {s}_{f} \\ = α {s}_{f}\end{matrix} & ( 9 )\end{matrix}$$

Note that α is a real number and represents an equivalent amplitude gain. As expressed by Equation (9), since the receive filter W_{RX(f)} is determined in Equation (8) such that a component (H_{M→f}W_{TX(m)}sₘ) that causes interference coming from the macrocell may be eliminated, the term of a component (W_{RX(f)}H_{M→f}W_{TX(m)}sₘ) that represents interference becomes zero by multiplying the component that represents interference and the receive filter W_{RX(f)} together and the component that represents interference is eliminated. In contrast, about a desired signal from the femtocell, the receive filter W_{RX(f)} is taken into account in the case where the transmit filter W_{TX(f)} in the base station apparatus F is calculated. Thus, a desired signal s_{f} may be extracted by performing multiplication using the receive filter W_{RX(f)}. Moreover, in the case where a scalar α, which and s_{f} are multiplied together in Equation (9), is also compensated, a structure may be used in which α is calculated by taking the equivalent channel matrix H_{F→f}W_{TX(f)} estimated by the channel estimation unit 105 and the receive filter W_{RX(f)} into account and a signal expressed as Equation (9) is divided by α. Moreover, the present embodiment employs a structure in which a desired signal is extracted by simply using the receive filter W_{RX(f)} calculated earlier by the receive filter. However, at the time of data transfer, if there is a state in which it is possible to estimate an equivalent channel matrix H_{M→f}W_{TX(m)} for interference coming from the macrocell, the equivalent channel matrix is estimated, a receive filter is calculated again in accordance with Equation (7), and the receive filter is used to extract a desired signal. As a result, the effect of a channel that changes with time may be suppressed. A demodulation unit 111 demodulates a desired signal s_{f} input from the receive filter multiplication unit 101 and outputs a resulting signal to an upper layer 113.

As described above, in accordance with the number of streams to be transmitted in a macrocell which are significantly large sources that cause interference in a femtocell and the degrees of freedom (the number of receive antennas) of a terminal device in the femtocell, the number of streams to be transmitted in the femtocell is determined such that the sum of the number of streams to be transmitted in the macrocell and the number of streams to be transmitted in the femtocell does not exceed the degrees of freedom of the terminal device. As a result, the terminal device in the femtocell may receive a desired signal while eliminating interference coming from the macrocell.

The base station apparatus F in the present embodiment calculates the transmit filter W_{TX(f)} on the basis of Equation (5). However, in a current system, alternatives of a transmit filter matrix that may be selected and called a code book have been defined in advance in order to reduce the amount of control information, and one matrix that maximizes transmission characteristics may be selected from among the alternatives. For example, in an LTE (Long Term Evolution) system, 16 kinds are defined in the case of 4 transmit antennas. Thus, selection standards in the case where a code book is used in the present embodiment are standards with which Equation (10) has the largest value. It is generally possible to treat a matrix selected in this way as the transmit filter W_{TX(f)}.

[Math. 10]

∥W_{RX(f)}H_{F→f}W_{TX(f)}∥² (10)

In the present embodiment, a case where the terminal device m is positioned near the femtocell is assumed as an example of the case where the terminal device f receives large interference from the macrocell. Similarly, in the case where the terminal device m in the macrocell is positioned at a place far from the femtocell, too, the present embodiment may have a structure in which the base station apparatus M and the base station apparatus F share number-of-streams information and the above-described processing is performed. This may be realized by transmitting the number of streams to be transmitted in a macrocell to a femtocell in the case where a base station apparatus in the macrocell knows the position of the femtocell and furthermore knows the current position of a terminal device m by using a GPS function or the like, and the terminal device m is apart from the femtocell by a distance that is greater than or equal to a predetermined threshold. Moreover, it is also possible to know how far a place at which the terminal device m is positioned is from the femtocell by measuring the level of a signal received by the terminal device m, the signal having been transmitted from the femtocell. With such a structure, a situation in which a signal transmitted from a femtocell greatly affects the terminal device m in a macrocell may be prevented.

Moreover, a structure may be used in which processing shown in the present embodiment is performed only for a femtocell, which is close to the base station apparatus M. This is because, since reception characteristics are significantly degraded due to the effect of a signal transmitted from the base station apparatus M in a femtocell, which is close to the base station apparatus M, the effect of eliminating interference using a linear filter shown in the present embodiment is significantly large. In this way, in the case where on/off of the present embodiment is switched therebetween in accordance with the position of the base station apparatus M and that of a femtocell, at the time when a femtocell is set, a user notifies an operator of the position of the femtocell and the operator registers the position of the femtocell. Thus, the operator knows the distance between the femtocell and the base station apparatus M of the closest macrocell. In the case where the distance is significantly short, the femtocell is notified of the fact that the distance is significantly short. As a result, processing shown in present embodiment may be switched to on. Moreover, a femtocell itself may know a positional relationship between a macrocell and the femtocell by using a GPS function or measuring, in the femtocell, the level of interference coming from the macrocell. As a result, on/off of the present embodiment may be switched therebetween.

### Second Embodiment

Next, a second embodiment of the present invention will be described.

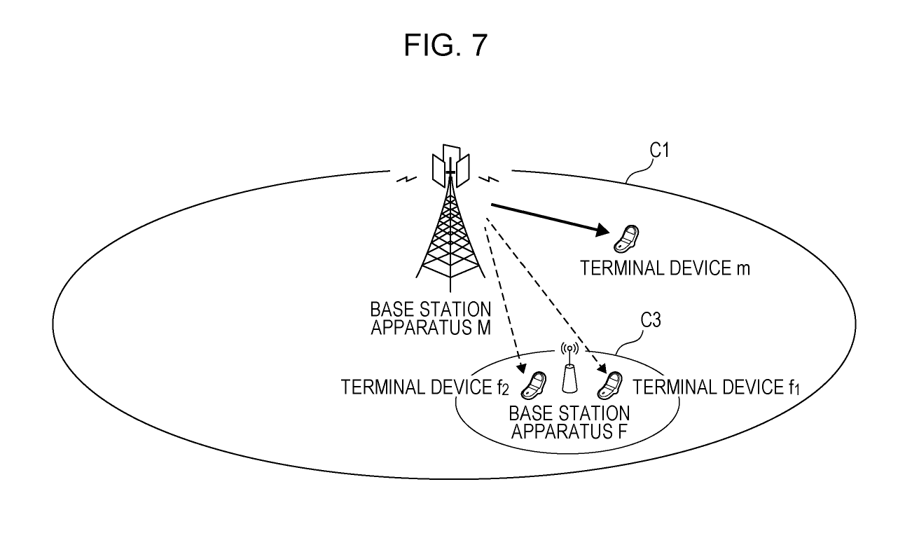

FIG. 7 illustrates the structure of a communication system according to the second embodiment of the present invention. As illustrated in FIG. 7, the macrocell C1 has a structure similar to that in the first embodiment. In a femtocell C3, the base station apparatus F and two terminal devices f₁ and f₂ perform transmission using MU-MIMO. Here, the terminal devices f₁ and f₂ receive a desired signal transmitted from the base station apparatus M to the terminal device m as a signal that causes interference. Moreover, here, the macrocell C1 and the femtocell C3 are assumed as an example. However, cells or zones constituted by Remote Radio Equipment, a picocell, HOTSPOT, a relay station, and the like may be used as targets as long as a plurality of cells having different zone radii are a combination of cells such that a desired signal in one cell causes interference in another cell. Furthermore, the present embodiment may be applied to such a situation in which a terminal device is positioned at a cell edge of two or more adjacent macrocells.

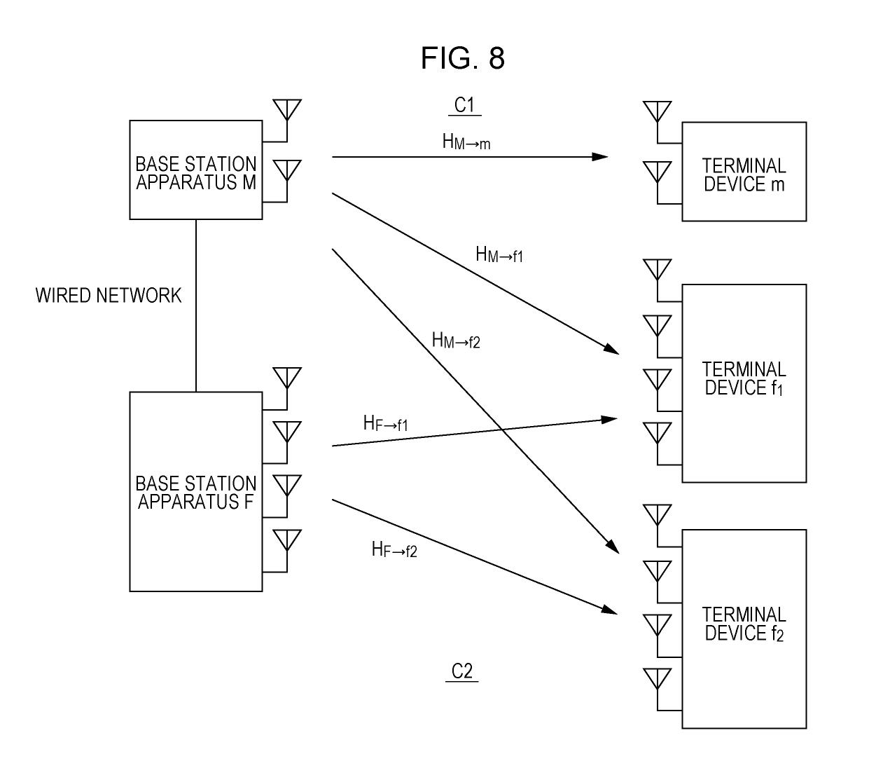

FIG. 8 illustrates details of a system structure of the present embodiment. The macrocell C1 (the base station apparatus M, the terminal device m) has a structure similar to that in FIG. 2. In the femtocell C3, the base station apparatus F has four transmit antennas. The terminal devices f₁ and f₂ each have four receive antennas. Here, a channel matrix between the base station apparatus F and the terminal device f₁ is denoted by H_{F→f1} and a channel matrix between the base station apparatus F and the terminal device f₂ is denoted by H_{F→f2}. In addition, a channel matrix between the base station apparatus M and the terminal device f₁ is denoted by H_{M→f1} and a channel matrix between the base station apparatus M and the terminal device f₂ is denoted by H_{M→f2}. A desired signal transmitted from the base station apparatus M to the terminal device m travels through a channel having the channel matrix H_{M→f1} and a channel having the channel matrix H_{M→f2} and is received by the terminal devices f₁ and f₂, respectively, as a signal that causes interference.

Moreover, the base station apparatus M and the base station apparatus F are connected with each other via a wired network (or may be connected in a wireless manner in the case of relaying). Information may be shared between the base station apparatuses M and F. Note that, a general RRE or a picocell base station often transmits information to and receives information from the base station apparatus M via an optical fiber or a dedicated network. The femtocell base station F often transmits information to and receives information from the base station apparatus M via the Internet, the femtocell base station F being connected to the Internet using an ADSL or an optical fiber.

<About Macrocell>

The base station apparatus M and the terminal device m in the present embodiment are similar to those in each of FIGS. 3 and 4.

<About Femtocell>

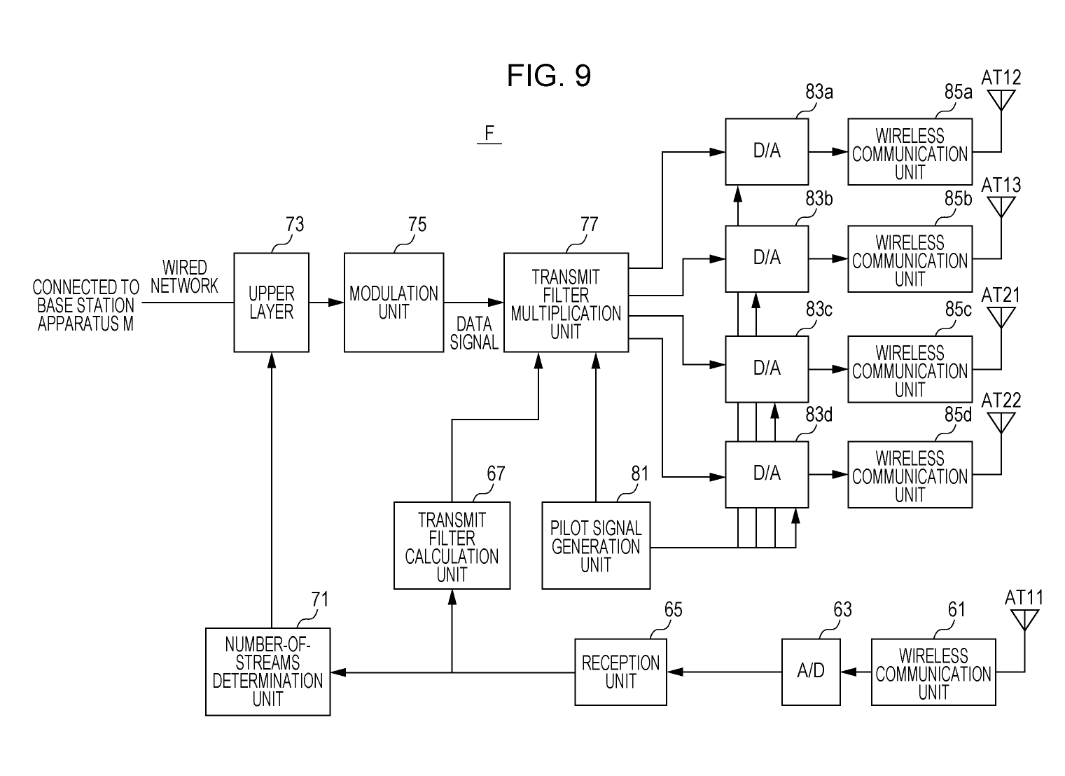

FIG. 9 illustrates the structure of the base station apparatus F in the femtocell C3 according to the present embodiment. In comparison with the structure illustrated in FIG. 5, there is a difference in a transmission system. Here, the transmission system is different from the structure illustrated in FIG. 5 in that the number of the D/A units 83a to 83d, the number of the wireless communication units 85a to 85d, and the number of the transmit antennas AT12, AT13, AT21, and AT22 are increased.

The base station apparatus F receives information transmitted from each of the terminal devices f₁ and f₂ and extracts transmitted information. The receive antenna AT11 receives a signal transmitted from the terminal device f₁. The wireless communication unit 61 downconverts a reception signal input from the receive antenna AT11 and generates a baseband signal. The A/D unit 63 converts an input analog signal into a digital signal and outputs the digital signal to the reception unit 65. The reception unit 65 extracts, from an input digital signal, information transmitted from the terminal device f₁. Specifically, the reception unit 65 extracts the channel matrix H_{F→f1}, number-of-receive-antennas information N_{f1} on the terminal device f₁, and a receive filter W_{RX(f1)} of the terminal device f, and outputs the channel matrix H_{F→f1} and the receive filter W_{RX(f1)} to a transmit filter calculation unit 127 and the number-of-receive-antennas information N_{f} to the number-of-streams determination unit 71. Likewise about the terminal device f₂, the reception unit 65 extracts information transmitted from the terminal device f₂ and outputs the channel matrix H_{F→f2} and a receive filter W_{RX(f2)} to the transmit filter calculation unit 67 and the number-of-receive-antennas information N_{f1} to the number-of-streams determination unit 71. Note that, as described also in the first embodiment, a structure may be used in which a multiplication result (an equivalent channel matrix) obtained by multiplying a channel matrix and a receive filter together is fed back and the equivalent channel matrix is extracted in the base station apparatus F.

In addition, the number-of-receive-antennas information does not have to be regularly transmitted from the terminal devices f₁ and f₂ to the base station apparatus F. A structure may be used in which the terminal devices f₁ and f₂ transmit the number-of-receive-antennas information only once in the case where an initial connection is established with the base station apparatus F.

The number-of-streams determination unit 71 determines the number of streams R_{F1} and the number of streams R_{F2} transmitted from the base station apparatus F to the terminal devices f₁ and f₂, respectively, such that conditions expressed as Equation (11) are met.

[Math. 11]

R_{F1}≦N_{f1}−Rₘ

R_{F2}≦N_{f2}−Rₘ

R_{F}≦N_{F} (11)

Note that R_{F}=R_{F1}+R_{F2}.

Here, Rₘ represents the number of streams to be transmitted to the terminal device m from the base station apparatus M. For example, this information is shared between the base station apparatus M and the base station apparatus F by using a method in which the base station apparatus M and the base station apparatus F are connected in a wired manner or the like, and the information has been transmitted in advance from the base station apparatus M to the base station apparatus F. In addition, N_{F} represents the number of transmit antennas of the base station apparatus F.

The first equation of Equation (11) indicates that the number of streams R_{F1} transmitted to the terminal device f₁ is calculated such that the number of streams R_{F1} is smaller than or equal to the result obtained by subtracting the number of signals that cause interference received from the base station apparatus M from the number of receive antennas of the terminal device f₁. Similarly to as in the first embodiment, this is on the condition that the number of receive antennas is greater than or equal to the sum of the number of signals that cause interference and the number of desired streams.

Similarly to this, the second equation of Equation (11) indicates that the number of streams R_{F2} transmitted to the terminal device f₂ is calculated such that the number of streams R_{F2} is smaller than or equal to the result obtained by subtracting the number of signals that cause interference received from the base station apparatus M from the number of receive antennas of the terminal device f₂. Similarly to as in the first embodiment, too, this is on the condition that the number of receive antennas is greater than or equal to the sum of the number of signals that cause interference and the number of desired streams.

Moreover, the third equation of Equation (11) indicates that the number of all streams R_{F} in the femtocell C3 is smaller than or equal to the number of transmit antennas of the base station apparatus F. In the case where the numbers of streams to be transmitted to the terminal devices are determined using only the first and second equations, a situation may occur in which the sum of the numbers of streams is larger than the number of transmit antennas of the base station apparatus F and transmission of the streams, the number of which is equal to the sum, is not possible. The third equation may be called an equation that represents a limit in order to prevent such a situation from occurring.

That is, Equation (11) represents conditions for calculation of the number of streams that the terminal device f₁ may receive and the number of streams that the terminal device f₂ may receive from the base station apparatus F while eliminating interference received from the base station apparatus M. Note that, in this way, if there is an equation that may be a standard for calculation of the number of streams that each terminal device may receive from the base station apparatus F while eliminating interference received from the base station apparatus M, the conditions are not limited to Equation (11). The numbers of streams may be calculated using another equation.

Since N_{f1}=4, N_{f2}=4, Rₘ=2, and N_{F}=4 in the present embodiment, the number-of-streams determination unit 71 first sets R_{F1}≦2 and R_{F2}≦2 from the first and second equations of Equation (11). Since this always satisfies R_{F}=R_{F1}+R_{F2}≦N_{F} of the third equation, next, control is performed such that R_{F1} and R_{F2} that satisfy R_{F1}≦2 and R_{F2}≦2 are calculated. Here, as combinations of R_{F1} and R_{F2} that satisfy R_{F1}≦2 and R_{F2}≦2 in the case where a signal is transmitted to both the terminal devices f₁ and f₂, there are combinations of streams such as (R_{F1}, R_{F2})=(1, 1), (2, 1), (1, 2), and (2, 2). Any combination therefrom may be used. For each terminal device, which combination is selected to set the number of streams to be transmitted to the terminal device from among these combinations may be determined in accordance with the reception quality of the terminal device, the amount of information that should be transmitted to the terminal device, and the like. Moreover, in the present embodiment, each terminal device is not configured to feed back information regarding the number of desired streams to a base station. In the case where such information is fed back, a combination of R_{F1} and R_{F2} may be determined in accordance with the information.

In addition, in the case where Rₘ=3, first R_{F1}≦1 and R_{F2}≦1 are set. This result always satisfies the third equation of Equation (11), too. Thus, next, control is performed such that a combination of R_{F1} and R_{F2} is calculated that satisfy R_{F1}≦1 and R_{F2}≦1. Here, in the case where a signal is transmitted to both the terminal devices f₁ and f₂, the combination is determined to be (R_{F1}, R_{F2})=(1, 1).

In the case where Rₘ=4, R_{F1}≦0 and R_{F2}≦0 are obtained. Thus, transmission of a signal is not performed in the femtocell C3.

In the case where Rₘ=0, R_{F1}≦4 and R_{F2}≦4 are obtained. There may be a case where this does not satisfy the third equation of Equation (11). For example, in the case where R_{F1}=4 and R_{F2}=4, R_{F}=8 is obtained. In this case, it exceeds the maximum number of streams that the base station apparatus F is capable of transmitting, which is four, it is actually impossible to perform transmission. Thus, a combination of R_{F1} and R_{F2} is determined to be R_{F1}≦4 and R_{F2}≦4 such that R_{F}≦N_{F} is satisfied. Such a combination is one of (R_{F1}, R_{F2})=(1, 1), (2, 1), (3, 1), (1, 2), (2, 2), and (1, 3) in the case where a signal is transmitted to both the terminal devices f₁ and f₂. As described above, for each terminal device, which combination is selected to set the number of streams to be transmitted to the terminal device from among these combinations of the numbers of streams may be determined in accordance with the reception quality of the terminal device, the amount of information that should be transmitted to the terminal device, and the like.

In addition, in the case where Rₘ=1, R_{F1}≦3 and R_{F2}≦3 are obtained. There may also be a case where the third equation of Equation (11) is not satisfied such as in the case where R_{F1}=3 and R_{F2}=3. Thus, a combination of R_{F1} and R_{F2} is determined to be R_{F1}≦3 and R_{F2}≦3 such that R_{F}≦N_{F} is satisfied.

For each terminal device, the number of streams to be transmitted to the terminal device determined in this way is output from the number-of-streams determination unit 71 to an upper layer. In the present embodiment, in the case where N_{f1}=4, N_{f2}=4, Rₘ=2, and N_{F}=4, the number-of-streams determination unit 71 outputs, for example, R_{F1}=R_{F2}=2 to the upper layer. In such a case, the base station apparatus F performs transmission using MU-MIMO in which two streams are transmitted to each terminal device. In the following, this case is used as an example, and a method for calculating a transmit filter will be described.

The transmit filter calculation unit 67 calculates, as expressed by Equation (12), the transmit filter W_{TX(f)} from the channel matrices H_{F→f1} and H_{F→f2} and the receive filters W_{RX(f1)} and W_{RX(f2)} transmitted from the terminal devices. Here, the transmit filter W_{TX(f)} is a transmit filter for performing precoding for the number of streams to be transmitted, in the base station apparatus F.

$$\begin{matrix}[ Math . 12 ] & \\ {W}_{TX ( f )} = {( \begin{matrix}{W}_{RX ( {f}_{1} )} & {H}_{F \to {f}_{1}} \\ {W}_{RX ( {f}_{2} )} & {H}_{F \to {f}_{2}}\end{matrix} )}^{- 1} & ( 12 )\end{matrix}$$

Here, the transmit filter W_{TX(f)} expressed as Equation (12) is a ZF filter. That is, two streams are transmitted using MU-MIMO from the base station apparatus F to each terminal device in the present embodiment. By using the transmit filter expressed as Equation (12), a method is performed in which each terminal device receives each stream using a corresponding antenna.

Moreover, as another precoding method in the case where a plurality of streams are transmitted using MU-MIMO, there is BD (Block Diagonalization), which may be applied to the present embodiment. In the present embodiment, in the case where BD is used, a method is performed in which a plurality of two streams are received by a plurality of antennas. In this case, the transmit filter is calculated using SVD as in the following.

[Math. 13]

W_{RX(f}_{₁}₎H_{F→f}_{₁}=U_{f}_{₁}D_{f}_{₁}V_{f}_{₁}^{H}

W_{RX(f}_{₂}₎H_{F→f}_{₂}=U_{f}_{₂}D_{f}_{₂}V_{f}_{₂}^{H} (13)

Here, as expressed by Equation (13), from among right-singular vectors V obtained by performing SVD on an equivalent channel matrix, the complex conjugate transpose vectors of right-singular vectors, which correspond to zeros that are diagonal elements of a singular value matrix D, are denoted by V_{f1}′ and V_{f2}′. Here, V_{f1}′ represents a filter for performing null steering for the terminal device f₁ from the base station apparatus F and V_{f2}′ represents a filter for performing null steering for the terminal device f₂ from the base station apparatus F. Here, in the case where R_{F1}=R_{F2}=2, both V_{f1}′ and V_{f2}′ are a matrix with four rows and two columns.

[Math. 14]

W_{RX(f}_{₁}₎H_{F→f}_{₁}V_{f}_{₂}′=U_{f}_{₁₁}D_{f}_{₁₁}V_{f}_{₁₁}^{H}

W_{RX(f}_{₂}₎H_{F→f}_{₂}V_{f}_{₁}′=U_{f}_{₂₂}D_{f}_{₂₂}V_{f}_{₂₂}^{H} (14)

Here, in the case where a vector obtained by multiplying V_{f2}′ by a right-singular vector V_{f11} obtained by performing SVD on Equation (14) is denoted by V_{f1}″ and a vector obtained by multiplying V_{f1}′ by a right-singular vector V_{f22} is denoted by V_{f2}″, the transmit filter W_{TX(f)} in the case where BD is used is expressed as Equation (15). Note that, in this example, V_{f11} and V_{f22} are each a matrix with two rows and two columns and V_{f1}″ and V_{f2}″ are each a matrix with four rows and two columns.

[Math. 15]

W_{TX(f)}=[V_{f}_{₁}″V_{f}_{₂}″] (15)

Similarly to as in the first embodiment, in reception processing in the present embodiment, in each terminal device, a signal that causes interference coming from a macrocell is eliminated using the receive filter W_{RX(f)} calculated by performing SVD on an equivalent channel matrix. Here, in the case where BD is used, a structure may be used in which the base station apparatus F transmits a left-singular vector U_{f11} expressed in Equation (14) to the terminal device f₁ and a left-singular vector U_{f22} to the terminal device f₂; in each terminal device, a signal is obtained by performing multiplication using the receive filter W_{RX(f)}; a plurality of streams transmitted to the terminal device are separated by multiplying the signal and U_{f11} together or by multiplying the signal and U_{f22} together (separation is performed for transmission using SU-MIMO). Note that, in each terminal device, this U_{f11} or U_{f22} may be estimated.

Moreover, in the case where separation is performed on a signal obtained by performing MIMO multiplexing in each terminal device, a transmit filter may be W_{TX(f)}=[V_{f2}′V_{f1}′] using V_{f1}′ and V_{f2}′ expressed in Equation (13), the separation being performed by performing reception based on MMSE criterion. The processing performed by the terminal device in this case will be described later.

In the upper layer 73, the transmission information symbol d_{f} for the number-of-streams information R_{F} is generated and output to the modulation unit 75. The modulation unit 75 modulates the transmission information symbol d_{f} into the transmission data signal s_{f} and outputs the transmission data signal s_{f} to the transmit filter multiplication unit 77.

The processing performed by the base station apparatus F thereafter is similar to that in the first embodiment. A transmission signal and a transmit filter calculated by the transmit filter multiplication unit 77 are multiplied together and a pilot signal generated by the pilot signal generation unit 81 is added. A resulting signal is transmitted, via the D/A units 83a, 83b, 83c, and 83d and wireless communication units 85a, 85b, 85c, and 85d, from AT12, AT13, AT21, and AT22.

In addition, as described above, in the case where Rₘ=3, in the case where transmission is performed by performing distribution such that R_{F1}=R_{F2}=1, a transmit filter is calculated using the ZF method or the like described above and transmission using MU-MIMO is performed using the calculated transmit filter in which one stream for each terminal device is transmitted from the base station apparatus F to the terminal device. In addition, in the case where Rₘ=3, a signal may be transmitted to only one of the terminal devices f₁ and f₂ instead of performing of transmission using MU-MIMO. In this way, in the case where the number of streams to be transmitted in a femtocell is determined in accordance with the number of streams to be transmitted in a macrocell, processing may be performed in which multi-user transmission and single-user transmission is dynamically switched therebetween.

Furthermore, even in the case where Rₘ=0, transmission using MU-MIMO may be performed by performing distribution such that R_{F1}=R_{F2}=2. Even in such a case, a transmit filter may be calculated using the ZF or BD method described above. In addition, transmission using SU-MIMO may also be performed. In this case, the maximum number of streams that may be transmitted to a single terminal device is four.

In addition, even in the case where Rₘ=1, likewise, transmission using MU-MIMO may be performed by distributing streams such that (R_{F1}, R_{F2})=(2, 2), using the ZF or BD method. Moreover, streams may also be distributed to each terminal device such that R_{F1}≠R_{F2}. Note that since one of the degrees of freedom that a terminal device has needs to be used in order to eliminate a signal that causes interference coming from a macrocell, the maximum number of streams that may be transmitted to a single terminal device needs to set to three.

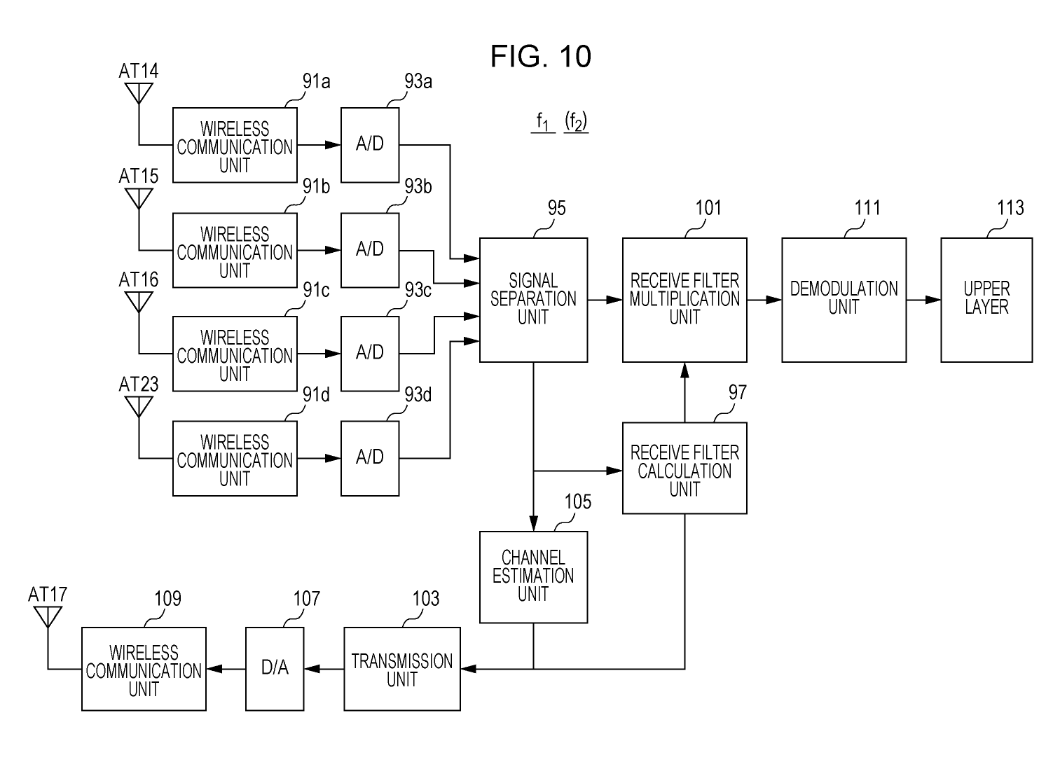

FIG. 10 illustrates the structure of the terminal device f₁ (f₂) according to the present embodiment. In comparison with the structure illustrated in FIG. 6, there is a difference in a reception system. Here, the reception system is different from the structure illustrated in FIG. 6 in that the number of receive antennas AT14, AT15, AT16, and AT23, the number of wireless communication units 91a to 91d, and the number of A/D units 93a to 93d are increased. A terminal device in the present embodiment has four receive antennas (AT14, AT15, AT16, and AT23), and a reception signal is input to the signal separation unit 95 via the wireless communication units 91a, 91b, 91c, and 91d and the A/D units 93a, 93b, 93c, and 93d.

Processing performed by each terminal device is similar to that in the first embodiment. A reception signal is separated into reception data and a pilot signal. The receive filter multiplication unit 101 extracts a transmission signal by multiplying the reception data and the receive filter W_{RX(f)} together. Note that, the receive filter W_{RX(f)} has been calculated in advance using Equation (7) similarly to as in the first embodiment. Moreover, the channel estimation unit 105 estimates the channel matrix H_{F→f} from a pilot signal for channel estimation and feeds back the channel matrix H_{F→f} together with the receive filter W_{RX(f)} and the number-of-receive-antennas information N_{f} to the base station apparatus F.

Note that, in the case where the base station apparatus F performs precoding using BD, after multiplication using the receive filter W_{RX(f)}, a plurality of streams transmitted to a single terminal device may be separated from each other by performing multiplication using the complex conjugate transpose vectors of left-singular vectors expressed in Equation (14). In addition, in the case where reception based on MMSE criterion is performed, the channel estimation unit 105 estimates an equivalent channel matrix. The receive filter multiplication unit 101 multiplies a reception data signal and a receive filter calculated on the basis of the estimation result together. As a result, a plurality of streams may be separated from each other and extracted.

As described above, even in the case where transmission using MU-MIMO is performed within a femtocell, in accordance with the number of streams to be transmitted in a macrocell which are significantly large sources that cause interference in the femtocell and the degrees of freedom (the number of receive antennas) that a terminal device in the femtocell has, the number of streams to be transmitted in the femtocell is determined such that the sum of the number of streams to be transmitted in the macrocell and the number of streams to be transmitted in the femtocell does not exceed the degrees of freedom of the terminal device. As a result, the terminal device in the femtocell may receive a desired signal while eliminating interference coming from the macrocell.

In addition, in thee case where the number of streams Rₘ from the macrocell according to the present embodiment is two or three, even by aligning an equivalent channel matrix for interference coming from the macrocell and an equivalent channel vector for interference between users within the femtocell, the interference may be effectively eliminated within the range of the degrees of freedom that a terminal device has. In this case, the base station apparatus F performs precoding using the transmit filter W_{TX(f)} expressed as Equation (16). Note that, in this case, the base station apparatus F needs to know the transmit filter W_{TX(m)} in the base station apparatus M, and this may be obtained via a wired network from the base station apparatus M. Moreover, the terminal devices f₁ and f₂ within the femtocell may be configured such that equivalent channel matrices H_{M→f1}W_{TX(m)} and H_{M→f2}W_{TX(m)} are estimated and fed back to the base station apparatus F, respectively.

[Math. 16]

W_{TX(f}_{₁}₎=H_{F→f}_{₂}⁻¹H_{M→f}_{₂}W_{TX(m)}

W_{TX(f}_{₂}₎=H_{F→f}_{₁}⁻¹H_{M→f}_{₂}W_{TX(m)}

W_{TX(f)}=(W_{TX(f}_{₁}₎W_{TX(f}_{₂}₎) (16)

In addition, in the first and second embodiments, each terminal deice feeds back a channel matrix and a receive filter estimated at the terminal device to the base station apparatus F, and each terminal device eliminates interference coming from a macrocell using a receive filter identical to the transmitted receive filter. However, a receive filter based on MMSE criterion may be calculated instead of this receive filter. In this case, for each terminal device, a weight of a MMSE filter is expressed as Equation (17).

[Math. 17]

W_{RX(f)}=(H_{F→f}W_{TX(f)})^{H}(H_{F→f}W_{TX(f)}(H_{F→f}W_{TX(f)})^{H}+Σₘ+σ²I)^{-I}Σₘ=H_{M→f}W_{TX(m)}(H_{M→f}W_{TX(m)})^{H} (17)

Note that H_{F→f}W_{TX(f)} expressed in Equation (17) is an equivalent channel matrix estimated by the receive filter calculation unit 97 from a pilot signal for receive filter calculation. Moreover, σ² represents the inverse of an average reception SNR (or noise dispersion).

Moreover, although a transmit filter expressed as Equation (12) or (15) is used in the base station apparatus F in the present embodiment, a transmit filter calculated on the basis of MMSE criterion expressed as Equation (18) may also be used.

[Math. 18]

W_{TX(f}_{₁}₎=(W_{RX(f}_{₁}₎H_{F→f}_{₁})^{H}(W_{RX(f}_{₁}₎H_{F→f}_{₁}(W_{RX(f}_{₁}₎H_{F→f}_{₁})^{H}+σ²I)⁻¹

W_{TX(f}_{₂}₎=(W_{RX(f}_{₂}₎H_{F→f}_{₂})^{H}(W_{RX(f}_{₂}₎H_{F→f}_{₂}(W_{RX(f}_{₂}₎H_{F→f}_{₂})^{H}+σ²I)⁻¹

W_{TX(f)}=(W_{TX(f}_{₁}₎W_{TX(f}_{₂}₎) (18)

In the above-described embodiments, examples are shown in which a base station apparatus in a femtocell determines the number of streams to be transmitted by the base station apparatus, the station apparatus acquiring information regarding the number of streams to be transmitted in a macrocell. However, in the case where there is a central control station that controls a macrocell and a femtocell collectively, the central control station may acquire information regarding the number of streams to be transmitted in the macrocell and information regarding the number of receive antennas that a terminal in the femtocell has and may determine the number of streams to be transmitted by a base station apparatus in the femtocell on the basis of the pieces of information.

In the above-described embodiments, the structures illustrated in the attached drawings are not limited thereto. various modifications may be made within the range in which the present invention has an advantageous effect. In addition, various modifications may be made without departing from the scope of the invention.

Moreover, a program that realizes functions described in the present embodiments may be recorded on a computer readable recording medium and processing performed by each unit may be performed by making a computer system read and execute the program recorded on the recording medium. Note that, here, the “computer system” is a computer system that includes an OS and hardware such as peripheral devices and the like.

Moreover, the “computer system” includes a homepage production environment (or a display environment) in the case where the computer system uses a WWW system.

Moreover, the “computer readable recording medium” is a portable medium, examples of which are a flexible disk, a magneto-optical disk, a ROM, a CD-ROM, and the like, or a storage device, examples of which are a hard disk integrated in a computer system and the like. Furthermore, the “computer readable recording medium” includes a recording medium that dynamically holds a program for a short period of time such as a communication line in the case where a program is transmitted via a network such as the Internet or a communication line such as a telephone line, and a recording medium that holds a program for a predetermined time such as a volatile memory inside a computer system functioning a server or a client in such a case. Moreover, the program may be a program for realizing part of the above-described functions or may also be realized by combining the program and a program in which the above-described functions are described and which has already been recorded in a computer system.

### INDUSTRIAL APPLICABILITY

The present invention is applicable to a communication device.

### REFERENCE SIGNS LIST

AT . . . antenna, C1 . . . macrocell, C2, C3 . . . femtocell, M . . . base station apparatus, F . . . base station apparatus, m . . . terminal device, f . . . terminal device, 11 . . . upper layer, 15 . . . modulation unit, 17 . . . transmit filter multiplication unit, 21 . . . pilot signal generation unit, 23a, 23b . . . D/A unit, 25a, 25b . . . wireless communication unit, 31a, 31b . . . wireless communication unit, 33a, 33b . . . A/D unit, 35 . . . signal separation unit, 37 . . . channel estimation unit, 41 . . . demodulation unit, 43 . . . upper layer, 45 . . . transmission unit, 47 . . . D/A unit, 51 . . . wireless communication unit, 61 . . . wireless communication unit, 63 . . . A/D unit, 67 . . . transmit filter calculation unit, 71 . . . number-of-streams determination unit, 73 . . . upper layer, 75 . . . modulation unit, 77 . . . transmit filter multiplication unit, 81 . . . pilot signal generation unit, 83a, 83b . . . D/A unit, 85a, 85b . . . wireless communication unit, 91a, 91b, 91c . . . wireless communication unit, 93a, 93b, 93c . . . A/D unit, 95 . . . signal separation unit, 97 . . . receive filter calculation unit, 101 . . . demodulation unit, 103 . . . transmission unit, 105 . . . channel estimation unit, 107 . . . D/A unit, 109 . . . wireless communication unit, 111 . . . demodulation unit, 113 . . . upper layer.

The entire contents of all the publications, patents, and patent applications cited in the present specification are incorporated herein by reference.

1-12. (canceled)

13. A communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell,
wherein the number of streams to be transmitted by the second base station apparatus is determined on the basis of information regarding the number of streams to be transmitted by the first base station apparatus.

14. The communication system according to claim 13, wherein the second base station apparatus includes a number-of-streams determination unit that acquires information regarding the number of streams to be transmitted by the first base station apparatus and determines the number of streams to be transmitted by the second base station apparatus.

15. The communication system according to claim 13, wherein the second base station apparatus includes a number-of-streams determination unit that determines the number of streams to be transmitted by the second base station apparatus on the basis of information regarding the number of streams to be transmitted by the first base station apparatus and the number of receive antennas that the second terminal device has.

16. The communication system according to claim 15, wherein the number-of-streams determination unit determines the number of streams to be transmitted by the second base station apparatus on the basis of a value obtained by subtracting the number of streams to be transmitted by the first base station apparatus from the number of receive antennas that the second terminal device has.

17. The communication system according to claim 13, wherein the second terminal device includes a channel estimation unit that estimates an equivalent channel matrix for a signal on which precoding has been performed and that is transmitted by the first base station apparatus, a receive filter calculation unit that calculates a receive filter on the basis of the estimated equivalent channel matrix, and a receive filter multiplication unit that multiplies a reception signal and the calculated receive filter together.

18. The communication system according to claim 17, wherein the receive filter calculation unit calculates the receive filter such that the receive filter is orthogonal to the equivalent channel matrix.

19. The communication system according to claim 18, wherein the second base station apparatus includes a transmit filter calculation unit that calculates a transmit filter used to perform precoding in the second base station apparatus, on the basis of an equivalent channel matrix obtained by multiplying a channel matrix between the second terminal device and the second base station apparatus and the receive filter together.

20. The communication system according to claim 19, wherein, in the case where streams are transmitted to the second terminal devices from the second base station apparatus, the second terminal devices receiving different streams, the transmit filter calculation unit calculates the transmit filter such that an equivalent channel matrix for an undesired stream that each of the second terminal devices receives is orthogonal to the receive filter.

21. A second base station apparatus in a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell, the second base station apparatus comprising:
a number-of-streams determination unit that acquires information regarding the number of streams to be transmitted by the first base station apparatus and determines the number of streams to be transmitted by the second base station apparatus.

22. A second terminal device in a communication system in which a first cell that covers a wide region includes, in a cover region thereof, a second cell that covers a smaller region than the first cell, one first terminal device or more positioned in the first cell receive a signal on which precoding has been performed and that is transmitted by a first base station apparatus that controls the first cell, and one second terminal device or more positioned in the second cell receive a signal on which precoding has been performed and that is transmitted using the same frequency as in the first cell by a second base station apparatus that controls the second cell, the second terminal device comprising:
a channel estimation unit that estimates an equivalent channel matrix for a signal on which precoding has been performed and that is transmitted by the first base station apparatus, a receive filter calculation unit that calculates a receive filter on the basis of the estimated equivalent channel matrix, and a receive filter multiplication unit that multiplies a reception signal and the calculated receive filter together.
